(19) United States
(12) Patent Application Publication
(10) Pub. No.: US 2006/0150783 A1
(43) Pub. Date: Jul. 13, 2006

(54) Multiple purpose, multiple use tool used for installing/servicing toilets and in particular two piece toilets

(76) Inventor: David Alan Thompson, Stanton, CA (US)

Correspondence Address: David Alan Thomposon, 8440 Cerritos Ave. Unit J, Stanton, CA, 90680, US

(21) Appl. No.: 11/032,471

(22) Filed: Jan. 10, 2005

(51) Int. Cl. B25B 13/00

(52) U.S. Cl. 81/124.4; 81/437

(57) ABSTRACT

I, David Alan Thompson, do hereby attest and avow that I have invented a new design for the manufacture and use of a portable multiple use hand tool for use in the installation and servicing of plumbing fixtures specifically toilets and specifically two piece toilets. This innovative invention has multiple functions and does a myriad of tasks. The invention contains a plurality of open-ended socket wrench heads, movable and or removable and a removable two size screwdriver tip. One of the socket wrench heads is slotted and notched to be able to admit a water supply line and water supply line type wing nuts respectively. In as illustrated in the accompanying drawings, this design is unique to the plumbing field and also the private sector to be used in the installation of toilets in both a commercial and residential application. Specifications for such are also included. No other parties other than listed in the accompanying application forms took part in the inception, conception, construction or formulation of this idea and design. I attest and avow that the foregoing statements are true to the best of my knowledge.

### CROSS REFERENCE TO RELATED APPLICATION

Not applicable.

### STATEMENT REGARDING FEDERALLY SPONSORED RESEARCH OR DEVELOPMENT

Not Applicable.

### REFERENCE TO SEQUENCE LISTING, A TABLE OR COMPUTER PROGRAM LISTING COMPACT DISC APPENDIX

Not Applicable.

### BACKGROUND OF INVENTION/DETAILED DESCRIPTION

My invention is for use in the plumbing field. It will be utilized in the installation and or servicing, repairing of plumbing fixtures and more specifically toilets and even more specifically two piece toilets in both commercial and residential applications. My invention is a multi faceted multi purpose tool that tightens and loosens the most common size connectors (nuts, bolts, screws, wing nut style connectors etc.) as is found on most toilets and in particular two piece toilets. It is an improvement over the customarily used tools that most people use to install and or service toilets. The tools most people use to install and or service toilets are as follows; adjustable channel locks, adjustable crescent wrench, standard and ratcheting wrenches, socket wrenches, pliers and phillips and standard screwdrivers. These tools do an adequate job however why use a variety of tools when one will do the job. My tool that fits in the palm of your hand replaces all those tools for the specific task and or tasks involved with repairing, installing and servicing toilets and in particular two piece toilets. It does the job and or jobs of the aforementioned tools as well as or better than them for the tasks involved with working on and or servicing, repairing and or installing toilets. Most multi-purpose tools either do not do all the required tasks they are intended for or do not do them very well, not so with my tool. It is simple, clever and innovative. It has a multitude of functions that do a myriad of tasks. It has a minimum of ten functions that do all the tasks required when working on, servicing, repairing and installing toilets. It works on the majority of toilets manufactured and does the majority of tasks involved with servicing and installing toilets the majority of the time. This tool is designed to aid anyone who is attempting to service and or install a toilet. It can be manufactured in basically one piece as is with the working prototype I fashioned myself or with movable pieces as the accompanying drawings will illustrate. It can be made out of many different types of metal and even be made of plastic. The Working prototype I have is made of high carbon steel I fashioned from tools I cut up and had welded together. Other features of said invention will appear in the following detailed description of said invention and in conjunction with the accompanying drawings.

Detailed description of the invention:

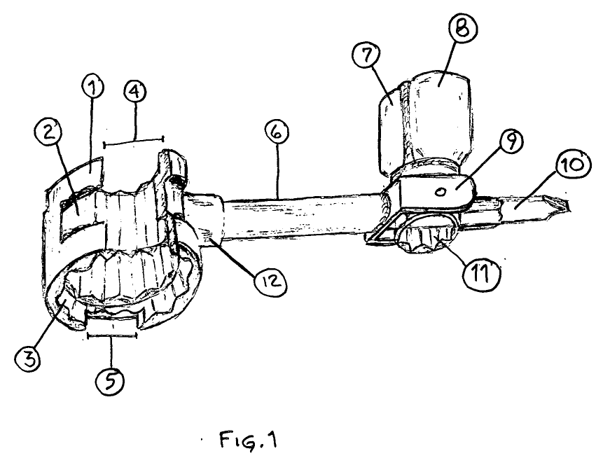

FIG. 1 is an overview of tool.

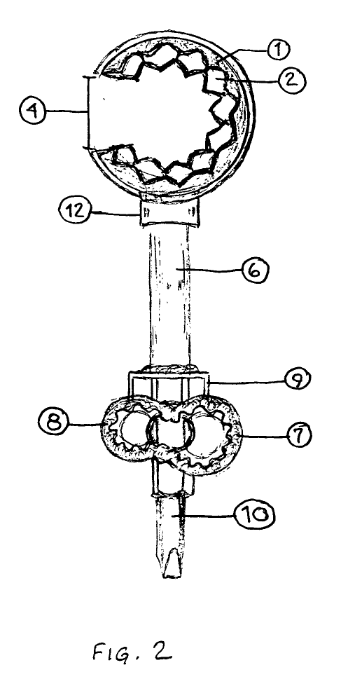

FIG. 2 is a top view of tool.

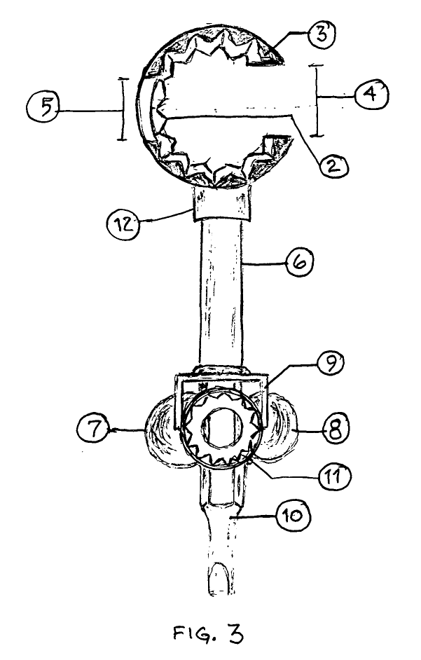

FIG. 3 is a bottom view of tool.

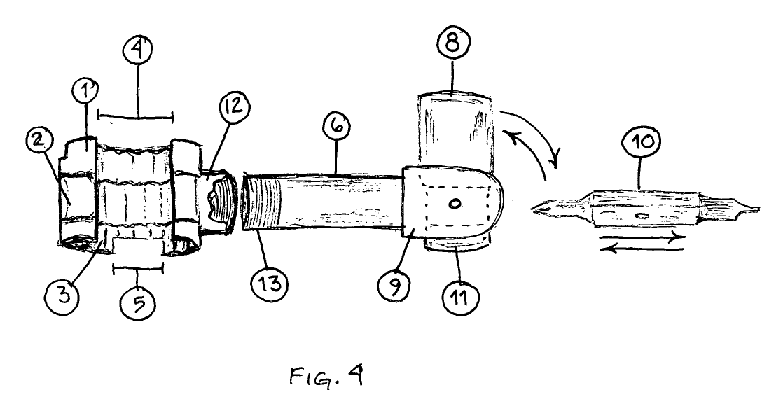

FIG. 4 is a view of movable, removable parts of tool.

While one embodiment of my invention is illustrated in the above referred drawings, it is understood that they are merely for the purpose of illustration and that various changes in the construction, material used, added functions etc. may be resorted to in the course of manufacture in order that the invention may be utilized to the best advantage according to circumstances which may arise without in any way departing from or deviating from the spirit and intention of the device which is limited only in accordance with the appended claims and while there is stated the primary field of the utility of the invention, it remains obvious that it may be employed in any other capacity wherein it might find use and be found applicable. In the accompanying drawings and in the following specifications the same numerical reference characters are used to designate the same parts and elements of the description of the tool throughout. The tasks that this multiple function tool does are as follows; It tightens/loosens the most common size hex nut that holds the toilet handle to the toilet tank (1). It tightens/loosens a very common size hex nut that holds the water supply line to the house shut off valve that feeds water to the toilet (2). It tightens/loosens several different variations of water supply line nut and thin fill valve nut at the water supply line that connects to the fill valve at the toilet tank and at the fill valve connection at the toilet tank respectively (3) and (5). It has a perpendicular slot at one of the heads that is wide enough to admit a water supply line and toilet handle rod that aids in accomplishing the above forementioned tasks (4). It has another slot on the face of the same above forementioned head that aids in tightening/loosening water supply line connectors that connect to the fill valve that are of the wing nut style (5). It has a shaft that connects both style driver heads that is hollow to accommodate a removable/reversible phillips/standard screwdriver tip (6) and (10). The second head has a socket that tightens/loosens four common size metric/American (SAE) hex nuts that holds and connects the toilet tank to the toilet bowl (7). It has an additional socket at the same head that tightens/loosens a larger size SAE hex nut that is also common that connects and holds the toilet tank to the toilet bowl and possibly a metric size that is close to that size (8). It has a fork (9) that connects to a third socket (11) that is connected to shaft (6). This fork has a pivot point (9) that allows that head to pivot a minimum of 180 degrees. It has a removable/reversible phillips/standard screwdriver tip (10) that can be used to tighten/loosen the screw heads that hold the toilet seat to the toilet bowl, adjust the water level via the fill valve as is with some of them, pry off decorative caps at toilet bowl etc. It has a third socket at same head that tighten/loosens a very common size hex nut that holds toilet bolts to closet flange and toilet bowl to same and to floor (11). It has female threading at first mentioned head (12) that makes possible this head being movable and or removable from hollow shaft (6) which has corresponding male threads (13). From the foregoing specifications it will become apparent that the invention disclosed will adequately accomplish the tasks for which it has been designed for and in an economic manner and that its'0 simplicity, accuracy and ease of operation are such as to provide a relatively inexpensive device considering all that it is able to accomplish and that it will find an important place in the art to which it pertains when once placed on the market for use by the general public and artisan it has been designed for. It is thought that persons skilled in the art for which this invention relates to will be able to obtain a clear and concise understanding of the invention after considering the description in relation to the drawings therefore a more lengthy description is deemed unnecessary. Changes in shape, size and arrangement of details and parts such as come within the purview of the invention claimed may be resorted to in actual practice, if so desired. It should also be duly noted and understood that the shape, size, height, depth and width of sockets and or socket heads will be determined as to what is best suited for the task or tasks each one is designed to perform.

I claim:

1. A multiple purpose hand tool comprising:
a plurality of open-faced socket wrench heads;
one multiple socket head having stacked multiple sizes and a perpendicular slot large enough to admit a toilet water supply line;
the second multiple socket wrench head being comprised of a single socket with multiple sizes, an additional socket size at bottom of said socket;
a hollow shaft connecting said socket wrench heads.

2. The hand tool of claim I wherein said shaft member has a hollow chamber for the storage of at least one spare multiple driver.

3. The hand tool of claim I further comprising a plurality of driver heads, each such driver head being movable and or removable.

4. The hand tool of claim I wherein has a minimum of three different working sizes on each workable head.

5. The hand tool of claim I wherein at least one of said open faced socket wrench heads are notched of at least one face of said wrench head, said opening being of sufficient size to admit a wing nut or wing nut style nut on a water supply line.

7. The hand tool of claim I wherein at least one of said open faced socket wrench heads is slotted, said slot aperture being at least and of a sufficient size to admit a water supply line.
